(19) United States
(12) Patent Application Publication
(10) Pub. No.: US 2026/0061967 A1
(43) Pub. Date: Mar. 5, 2026

(54) USER PROFILES FOR CONSUMERS

(71) Applicant: Textron Inc., Providence, RI (US)

(72) Inventors: Preston Sering Easley, Martinez, GA (US); Brianna Danielle Harrington, Augusta, GA (US)

(73) Assignee: Textron Inc., Providence, RI (US)

(21) Appl. No.: 18/824,503

(22) Filed: Sep. 4, 2024

(51) Int. Cl. B60R 25/25; B60R 25/04; B60R 25/08; B60R 25/30; B60R 25/31

(52) U.S. Cl. CPC B60R 25/252; B60R 25/04; B60R 25/08; B60R 25/255; B60R 25/257; B60R 25/305; B60R 25/31; B60R 2325/101; B60R 2325/103; B60R 2325/105; B60R 2325/205

(57) ABSTRACT

A golf cart system includes a golf cart and one or more processing circuits. The one or more processing circuits are configured to acquire a unique identifier associated with a user of the golf cart, determine one or more parameters associated with the unique identifier where the one or more parameters define one or more operating conditions of the golf cart, and permit operation of the golf cart by the user in accordance with the one or more operating conditions.

### BACKGROUND

Golf vehicles are used by consumers and families. By way of example, multiple people may utilize one golf vehicle.

### SUMMARY

One embodiment relates to a golf cart system. The golf cart system includes a golf cart and one or more processing circuits. The one or more processing circuits are configured to acquire a unique identifier associated with a user of the golf cart, determine one or more parameters associated with the unique identifier where the one or more parameters define one or more operating conditions of the golf cart, and permit operation of the golf cart by the user in accordance with the one or more operating conditions

Another embodiment relates to a recreational vehicle system. The recreational vehicle system includes a non-transitory computer-readable medium having instructions stored thereon that, when executed by one or more processors, cause the one or more processors to acquire a unique identifier associated with a user of a golf cart, determine one or more parameters associated with the unique identifier where the one or more parameters define one or more operating conditions of the golf cart, and permit operation of the golf cart by the user in accordance with the one or more operating conditions

Still another embodiment relates to a vehicle system. The vehicle system includes a non-transitory computer-readable medium having instructions stored thereon that, when executed by one or more processors, cause the one or more processors to: acquire a unique identifier associated with a user of a vehicle, wherein the unique identifier includes at least one of an access code or a credential, a biometric, or a short-range communication signal, determine one or more parameters associated with the unique identifier, wherein the one or more parameters define one or more operating conditions of the vehicle, acquire occupant data from one or more sensors of the vehicle regarding at least one of a number of occupants in the vehicle, a weight of the occupants in the vehicle, or a use of seatbelts by the occupants in the vehicle, the occupants including the user, permit operation of the vehicle by the user in accordance with the one or more operating conditions and based on the occupant data, determine that the vehicle is being operated beyond at least one of the one or more parameters, transmit a notification in response to the vehicle being operated beyond the at least one of the one or more parameters, detect that one or more of the occupants have exited the vehicle, and adjust operation of the vehicle based on updated occupant data.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a schematic block diagram of a user profile management system, according to an exemplary embodiment.

FIG. 5 is a flow diagram of a method of user profile generation, according to an exemplary embodiment.

FIG. 6 is a flow diagram of a method for controlling vehicle operation according to operating parameters based upon one or more occupants, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

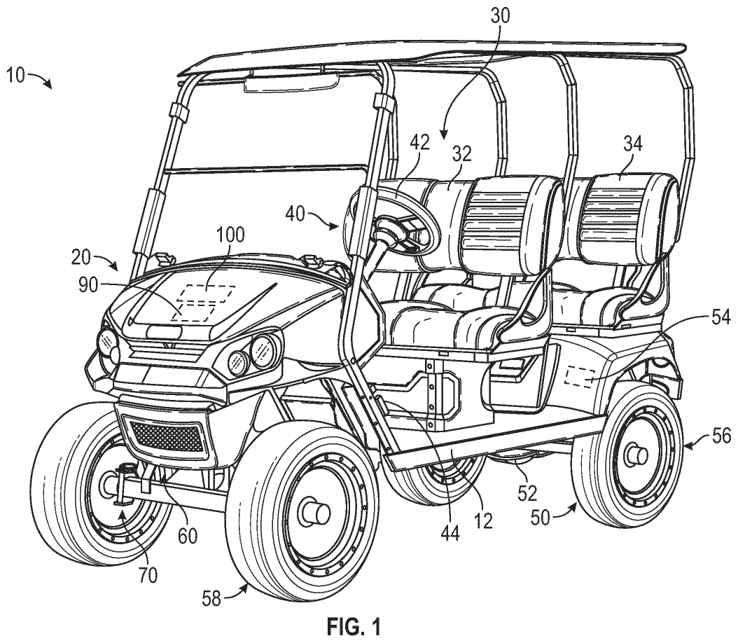

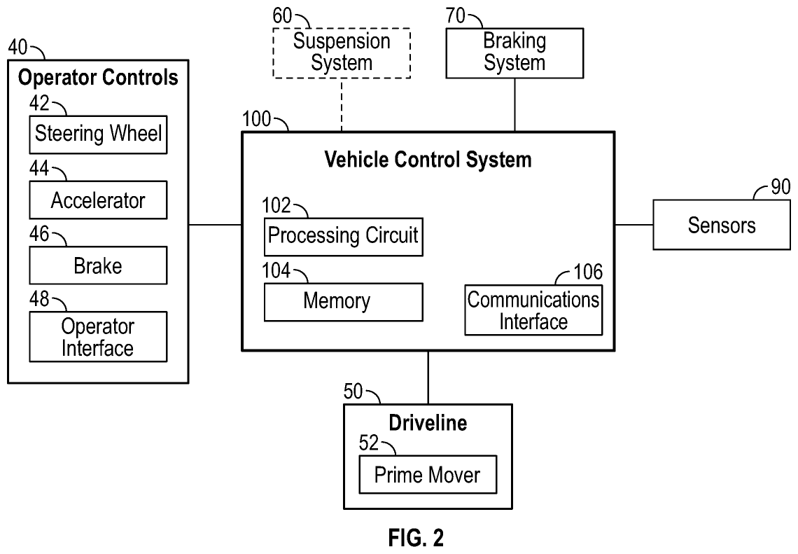

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), a personal transport vehicle (“PTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.).

According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

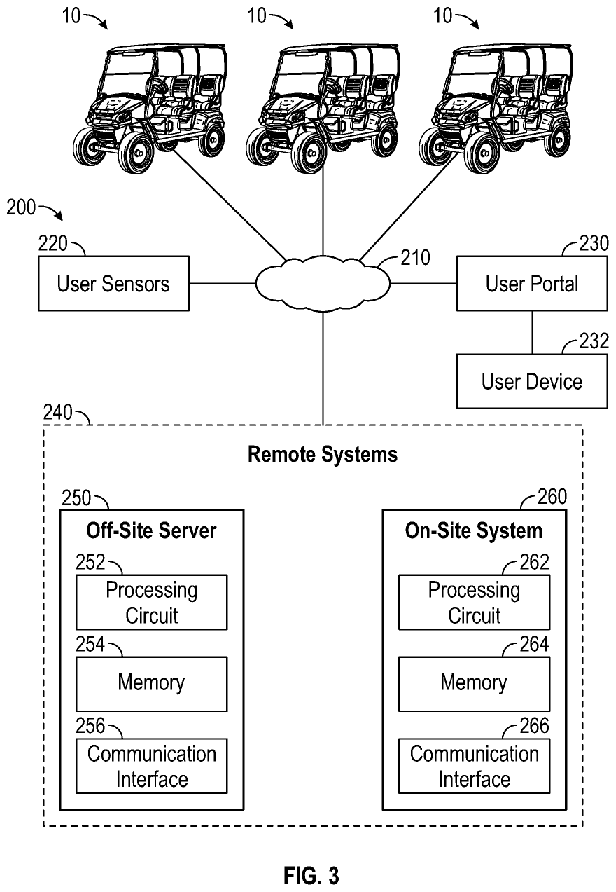

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the site monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 3, the user portal 230 is accessible via the user device 232. The user device 232 may be or include a computer, laptop, smartphone, tablet, or the like.

The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### User Profiles for Consumers

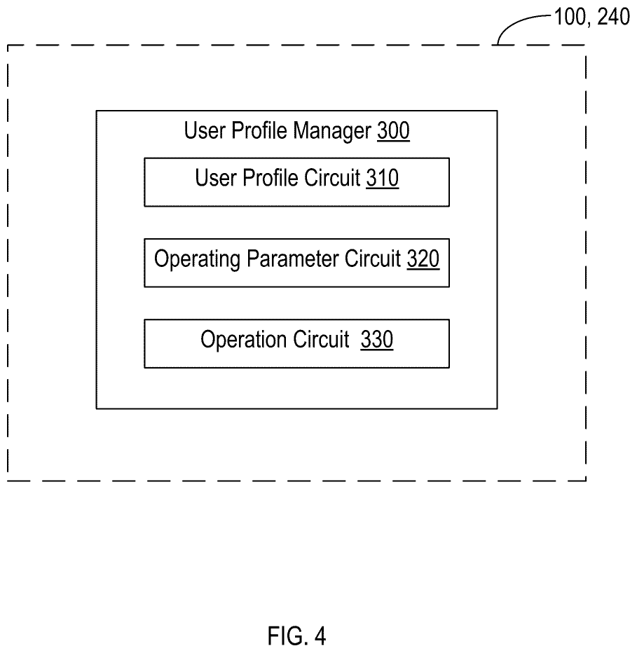

As shown in FIG. 4, a user profile management system, shown as user profile manager 300, includes a user profile circuit 310, an operating parameter circuit 320, and an operation circuit 330. By way of example, the user profile manager 300 may be part of the vehicle control system 100. In some examples, the user profile manager 300 may additionally or alternatively be part of the remote systems 240. In some examples, one or more components of the user profile manager 300 may be implemented as edge devices or computers located on the vehicle 10.

As shown in FIG. 4, the user profile manager 300 includes a user profile circuit 310, an operating parameter circuit 320, and an operation circuit 330. The user profile circuit 310 is or includes any device, component, element, or hardware designed or configured to generate or retrieve a user profile of a user of the vehicle 10. The user profile circuit 310 is communicably coupled to the operating parameter circuit 320 and the operation circuit 330.

The user profile circuit 310 is configured to acquire or generate a user profile for a user of the vehicle 10. The user profile is acquired or generated responsive to receipt of a user identifier associated with the user of the vehicle 10 or inputs received from the user of the vehicle 10. In some embodiments, one or more of the sensors 90 are configured to acquire occupant data regarding occupants (e.g., users) of the vehicle 10. The sensors 90 may be or include a camera (e.g., for facial recognition), a biometric sensor (e.g., a fingerprint scanner, a retinal scanner, a microphone for voice verification, etc.), one or more weight sensors, one or more seat switches, one or more seatbelt sensors, or an IMU. The occupant data includes information regarding the number, identity, size (e.g., weight), etc. of occupants in the vehicle 10. By way of example, the sensors 90 may facilitate determining, based on the occupant data, at least one of a number of occupants in the vehicle 10, a weight of the occupants in the vehicle 10, or an identity of one or more occupants within the vehicle 10. That is, in some embodiments, the sensors 90 are configured to detect when one or more occupants enter the vehicle 10 and/or who those occupants may be.

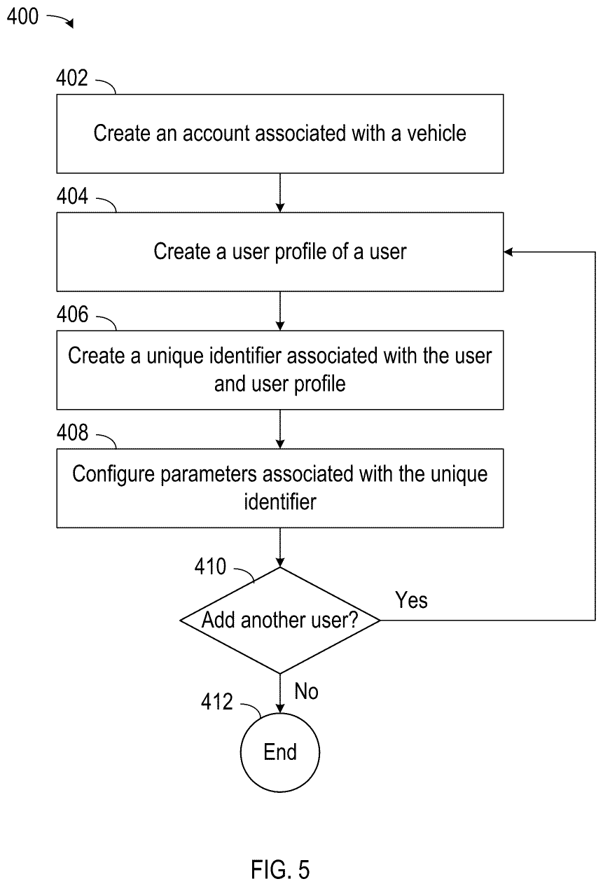

In various embodiments, users of the vehicle 10 each have an associated user profile linked to the vehicle 10. Generation of a user profile is described in greater detail with respect to FIG. 5. In some embodiments, upon entry into the vehicle 10, a user (e.g., one of the one or more occupants of the vehicle 10) logs in or otherwise accesses their associated user profile. By way of example, the user profile circuit 310 may acquire a unique identifier associated with the user of the vehicle 10 and their user profile via a user input of the unique identifier to an interface (e.g., the operator interface 48) or device of the vehicle 10. By way of example, the user may input the unique identifier to the operator interface 48, and the unique identifier may be transmitted to and/or acquired by the user profile circuit 310. The unique identifier includes at least one of an access code or a credential, a biometric (e.g., facial scan, fingerprint, retinal scan, voice input), or a short-range communication signal. Upon receipt of the unique identifier, the user profile circuit 310 may permit or grant access to the user to operate the vehicle 10. In various embodiments, for example when multiple occupants are in the vehicle 10, a driver of the vehicle 10 enters or provides their unique identifier.

In some embodiments, the unique identifier is or includes the access code or the credential. For example, the unique identifier may be one or more of a PIN number, a username, a password, etc. The operator interface 48 may be configured to receive the access code or the credential based on an input thereto by the user. For example, upon entry into the vehicle 10, the user may input, via the operator interface 48, a PIN number.

In some embodiments, the unique identifier is or includes the biometric. The biometric is any biological measurement or physical characteristic that is used to identify an individual (e.g., a user of the vehicle 10). In various embodiments, a biometric includes at least one of a fingerprint scan, a photograph of the user, a facial scan, a retinal scan, or a voice input.

Accordingly, in various embodiments, the vehicle 10 includes a biometric device configured to acquire the biometric. For example, the biometric device includes at least one of a fingerprint scanner, a camera, or a microphone.

In some embodiments, the unique identifier is or includes the short-range communication signal. By way of example, the short-range communication signal may be a signal transmitted from a portable device (e.g., associated with the user) to the vehicle 10. The portable device may be or include at least one of a smartphone, a smartwatch, an access fob, or a key. Additionally, the vehicle 10 may include a communications interface configured to acquire the short-range communications signal from the portable device. By way of example, the short-range communication signal is or includes RFID, NFC, or Bluetooth®. In some embodiments, the short-range communication signal includes the biometric acquired at the portable device.

Each user profile includes one or more stored identifiers that facilitate identification and/or verification of the user associated with the user profile. By way of example, a user may create a user profile and link a unique identifier with the profile. For example, when setting up the user profile, the user may add one or more of an access code, a credential, a biometric, and/or a short-range communication signal that will be used to determine and verify an identity of the user. For example, linking a unique identifier to the user profile may ensure that the correct user profile is acquired and/or generated upon receipt of the identifier in the future.

Upon receipt, by the user profile circuit 310, of the unique identifier from the vehicle 10, the user profile circuit 310 verifies the unique identifier. In some embodiments, the user profile circuit 310 stores or houses a database of user profiles. By way of example, the user profile circuit 310 may acquire, via a user input on the vehicle 10, the unique identifier. The user profile circuit 310 may compare the unique identifier with the identifiers linked to the user profiles in the database. Upon determining a match between the acquired unique identifier and an identifier linked to the user profile, the user profile circuit 310 retrieves the user profile and transmits the user profile and corresponding data to the vehicle 10 and/or one or more components of the user profile manager 300 (e.g., the operating parameter circuit 320).

The operating parameter circuit 320 is or includes any device, component, element, or hardware designed or configured to determine one or more parameters associated with the unique identifier and/or a user profile of a user. The operating parameter circuit 320 is communicably coupled to the user profile circuit 310 and the operation circuit 330.

The operating parameter circuit 320 is configured to receive or acquire, from the user profile circuit 310, a user profile of a user that has entered or provided their unique identifier to access the vehicle 10. The operating parameter circuit 320 is configured to determine one or more parameters associated with the unique identifier. The one or more parameters define one or more operating conditions of the vehicle 10. In various embodiments, and as will be described with reference to FIG. 5, a user profile designated as a managing user profile is able to configure, monitor, modify, etc. parameters associated with different user profiles linked to the same vehicle 10. By way of example, the one or more parameters include at least one of: a maximum speed of the vehicle 10, braking capabilities of the vehicle 10, turning capabilities of the vehicle 10, a maximum acceleration of the vehicle 10, permitted operating hours of the vehicle 10, a permitted duration of operation, a permitted number of passengers on the vehicle 10, available features to be displayed on a display screen of the vehicle 10, a permitted geofence of the vehicle 10, music selection, etc. The user may establish the one or more parameters associated with their unique identifier (and their user profile) upon generation of the user profile. The operating parameter circuit 320 may transmit the determined parameters associated with the unique identifier to the operation circuit 330. The operation circuit 330 may utilize the parameters to control operation of the vehicle 10 according to the operating conditions defined by the parameters.

In various embodiments, the user of the vehicle 10 changes or updates the operating parameters associated with the unique identifier. The operating parameter circuit 320 updates the parameters (and, thereby, the operating conditions defined by the parameters). By way of example, a user may configure parameters for the vehicle 10 to operate in accordance with when a child is operating the vehicle 10. When the child has grown, the user may desire to update the parameters. The user can access their user profile and modify the parameters. The operating parameter circuit 320 may receive the modifications from the user and update the parameters and user profile.

As described above, a parameter may be a permitted geofence of the vehicle 10. The operating parameter circuit 320 receives, from a user via a user interface, an indication of one or more zones, locations, perimeters, areas, etc. on a map that the user is permitted to operate the vehicle 10 in. In various embodiments, the sensors 90 are configured as GPS or location sensors configured to provide an indication of a location of the vehicle 10 to facilitate control of the vehicle 10 relative to the geofence. In various examples, the geofence is generated by referencing a database of location data correlated with location limit rules configured on a server (e.g., the remote systems 240) and deployed to the vehicle 10.

In various embodiments, the operating parameter circuit 320 determines parameters based on historical data. By way of example, the operating parameter circuit 320 may receive historical location data of the vehicle 10 and determine parameters (e.g., a permitted geofence) based on locations that the vehicle 10 has previously traveled. A user is able to approve, modify, deny, etc. the determined parameters. The operating parameter circuit 320 transmits the determined parameters to the operation circuit 330.

The operation circuit 330 is or includes any device, component, element, or hardware designed or configured to control operation of the vehicle 10. The operation circuit 330 is communicably coupled to the user profile circuit 310 and the operating parameter circuit 320.

The operation circuit 330 is configured to permit operation of the vehicle 10 by the user in accordance with the one or more operating conditions. The operation circuit 330 receives, from the operating parameter circuit 320, the parameters associated with a unique identifier of the user and the corresponding operating conditions defined by the parameters. By way of example, the operation circuit 330 may unlock or otherwise enable the vehicle 10 to be used by the user upon receipt of, for example, the verification of the unique identifier, the one or more parameters, the operating conditions, etc. Additionally, the operation circuit 330 communicates the operating conditions to one or more components of the operator controls 40, the driveline 50, the braking system 70, etc. such that the vehicle 10 operates within the bounds of the parameters and operating conditions when the user associated with the unique identifier is operating the vehicle 10. By way of example, parameters associated with the unique identifier may be a maximum speed of the vehicle 10 and a turning capability of the vehicle 10. When the user operates the vehicle 10, the operation circuit 330 may cause the steering wheel 42 to have restricted movement to align with the turning capabilities of the vehicle 10 defined by the operating conditions.

In various embodiments, the sensors 90 acquire information while the user operates the vehicle 10 and transmit the information to the operation circuit 330. Specifically, the sensors 90 may acquire occupant data regarding occupants of the vehicle 0. By way of example, the sensors 90 are at least one of a camera, one or more weight sensors, one or more seat switches, one or more seat belt sensors, or an (IMU installed on the vehicle 10. In various embodiments, the sensors 90 transmit the acquired occupant data to the operation circuit 330. The operation circuit 330 is configured to determine, using the occupant data, information related to the occupants including a number of occupants in the vehicle 10, identifying features of the occupants in the vehicle 10 (e.g., approximate ages, size, etc.), a weight of the occupants in the vehicle 10, a determination that at least one of the occupants in the vehicle 10 is not wearing a seatbelt, a determination that a user has entered or exited the vehicle 10, etc. In various embodiments, the operation circuit 330 also determines that the vehicle 10 is being operated beyond at least one of the one or more parameters.

In various embodiments, the operation circuit 330 permits operation of the vehicle 10 by the user in accordance with the one or more operating conditions and based on the occupant data acquired by the sensors 90. The sensors 90 continually transmit occupant data to the operation circuit 330 such that the operation circuit 330 continually monitors compliance of the operating conditions. Upon a determination by the operation circuit 330 that the users and/or vehicle 10 are not in compliance with the operating conditions, the operation circuit adjusts operation of the vehicle 10. By way of example, a parameter may be that the vehicle 10 is not to exceed 25 miles per hour. The sensors 90 may acquire a signal that the vehicle 10 is operating at 30 miles per hour. The operation circuit 330 may receive the signal from the sensors 90 and adjust operation of the vehicle 10. By way of another example, the operation circuit 330 may receive a signal from the sensors 90 indicating that an occupant has exited the vehicle 10. The operation circuit 330 may adjust operation of the vehicle 10 by braking the vehicle 10. Adjusting operation of the vehicle 10 includes any operation that bring operation of the vehicle 10 back in accordance with the parameters. For example, adjusting operation of the vehicle 10 may include reducing a speed of the vehicle 10, braking the vehicle 10, turning off the vehicle 10, limiting a turning ability of the steering wheel 42, etc.

In various embodiments, responsive to a determination by the operation circuit 330 that the vehicle 10 is being operated beyond the parameters, the operation circuit 330 transmits a notification to the user that the vehicle 10 is being operated beyond the parameters. For example, the operation circuit 330 may transmit a notification to a user device of the user (e.g., a mobile phone). The notification may include an indication that the vehicle 10 is operating beyond the parameters associated with the unique identifier of the user operating the vehicle 10. In various embodiments, a user associated with the managing user profile receives the notification. In various embodiments, the operation circuit 330 receives a user input indicative of permission from the user to override the one or more parameters for the vehicle 10.

By way of example, an operator of the vehicle 10 may be a child, and the occupants of the vehicle 10 may be the child's parents. The child's unique identifier may be acquired by the user profile circuit 310 and the vehicle 10 may be permitted to operate in accordance with the operating conditions defined by the parameters associated with the child's unique identifier. The child may operate the vehicle 10 beyond one of the parameters (e.g., the child operates the vehicle above the maximum speed defined by the parameter). The parent of the child may be associated with the managing user profile and may receive a notification from the operation circuit 330 that the vehicle 10 is being operated beyond the maximum speed. The parent may allow the vehicle to operate at the higher speed, and as such the operation circuit 330 receives a user input indicative of permission from the user to override the maximum speed parameter. If the parent did not allow the vehicle to operate at the higher speed, the operation circuit 330 may receive an indication and adjust operation of the vehicle 10 (e.g., reduce the speed of the vehicle 10 or stop the vehicle 10).

In various embodiments the sensors 90 perform image recognition and transmit the information to the operation circuit 330. For example, the sensors 90 perform image recognition and recognize each occupant of the vehicle 10, and transmit the information to the operation circuit 330. Based on the information, the operation circuit 330 adjusts operation of the vehicle 10. For example, the sensors 90 indicate that a small child is sitting in one of the seats of the vehicle 10 and/or that one or more occupants is not wearing a seatbelt. The operation circuit 330 recognizes this and limit turning capabilities of the vehicle 10 to prevent an occupant from falling out of the vehicle 10.

Referring now to FIG. 5, a block diagram for a method 400 for profile generation is shown, according to an exemplary embodiment. The method 400 may be executed by a first processing circuit located on the vehicle 10 (e.g., the vehicle control system 100) and/or a second processing circuit located remote from the vehicle 10 (e.g., the remote systems 240).

At step 402, one or more processing circuits create an account associated with a vehicle. By way of example, the one or more processing circuits receive an indication from a user to create an account associated with the vehicle 10. The user may generate the indication via a user interface of a user device. In various embodiments, the user interface is an application or web page associated with the vehicle 10 or the remote systems 240 (e.g., accessed via the operator interface 48, the user device 232, etc.). In various embodiments, the account is associated with multiple users of one vehicle. By way of example, the vehicle may be a golf cart for consumer or personal use by a family. Multiple family members may each have a user profile generated for using the golf cart, and all of the user profiles may be associated with the same account.

At step 404, one or more processing circuits create a user profile for a user associated with the account. The one or more processing circuits receive information from the user for use in creating the user profile. By way of example, the one or more processing circuits receive indications of a name, phone number, email address, gender, age, weight, height, etc. of the user for whom the user profile is being created. In various embodiments, a user profile is able to be designated as a managing profile. The managing profile is granted access and certain abilities over the other user profiles associated with the account. For example, a family may create four user profiles for two adults and two children. The users may designate one or more of the user profile for the parents as a managing profile. The managing profile may be able to modify the parameters associated with all of the user profiles, but the non-managing profiles may be unable to modify parameters associated with other user profile. In some embodiments, a managing profile approves any changes made to non-managing profile. For example, a managing profile may have to approve any updates to parameters associated with a non-managing profile before the updates are applied to the non-managing user profile.

At step 406, one or more processing circuits create a unique identifier associated with the user and user profile. By way of example, the one or more processing circuits may receive, from a user, a selection of one or more types of unique identifiers (e.g., an access code, a biometric, etc.) to be associated with their user profile. The one or more processing circuits receive an input of the unique identifier and store the input with the user profile. For example, a user may select a biometric for their unique identifier and may perform a biometric scan (e.g., a facial scan, a fingerprint scan, a voice recording, a retinal scan, etc.). The biometric scan may be performed via a device on the vehicle or via a user device and transmitted to the vehicle. The one or more processing circuits receive the biometric scan information and store the biometric scan information in the user profile. In various embodiments, the one or more processing circuits may enable two-factor authentication or another verification method associated with the unique identifier. For example, the two-factor authentication may (a) require a user to provide an input (e.g., an access code, a device identifier, etc.) to the vehicle and (b) verify a characteristic of the user (e.g., an identify, a weight, etc.) of the user using a sensor on the vehicle (e.g., a weight sensor, a biometric sensor, etc.) before permitting vehicle access to the user.

At step 408, one or more processing circuits configure parameters associated with the unique identifier. The one or more processing circuits receive inputs from the users, via a user interface, indicative of parameters to be associated with the user profile. By way of example, the one or more processing circuits may configure parameters that set a maximum speed, a maximum acceleration, a maximum number of occupants, certain operating hours, certain operating areas/geofences, etc. In various embodiments, a managing profile configures parameters for non-managing profiles.

At step 410, the one or more processing circuits receive an indication of whether an additional user is to be added to the account. For example, a family may add multiple user profiles to the account for each family member. Responsive to a determination by the one or more processing circuits that no additional users are to be added to the account, the method 400 ceases (e.g., at step 412) and the account and associated user profiles are created. Responsive to a determination by the one or more processing circuits that an additional user is to be added to the account, the method 400 returns to step 404.

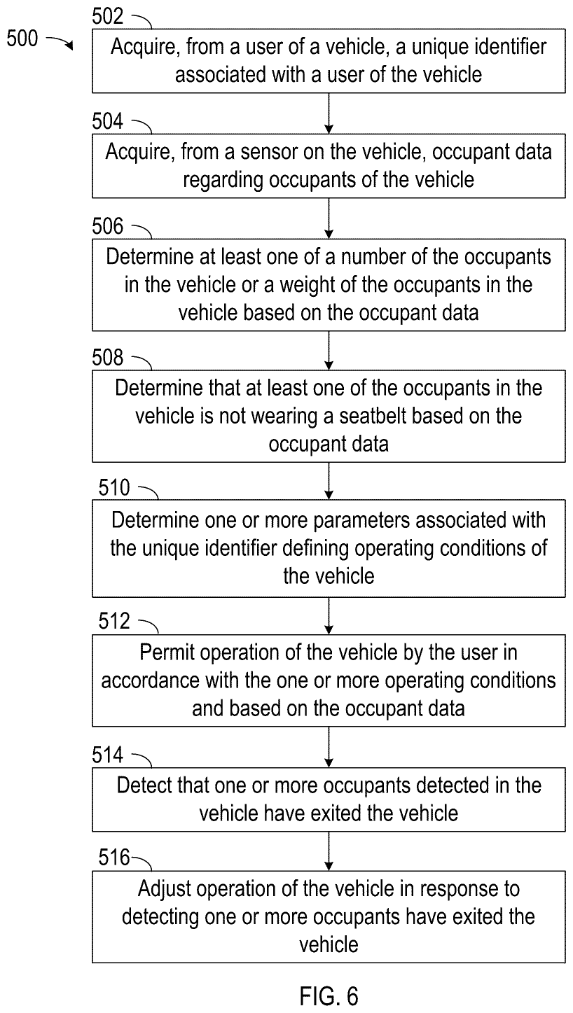

Referring now to FIG. 6, a block diagram of a method 500 for controlling vehicle operation according to operating parameters based upon one or more occupants is shown, according to an exemplary embodiment. One or more users may be in or on the vehicle 10. The method 500 may be executed by a first processing circuit located on the vehicle 10 (e.g., the vehicle control system 100) and/or a second processing circuit located remote from the vehicle 10 (e.g., the remote systems 240).

At step 502, one or more processing circuits (e.g., of the vehicle controller 100, of the remote systems 240, of the user profile manager 300, etc.) acquire, from a user of a vehicle, a unique identifier associated with a user of the vehicle. For example, the one or more processing circuits may receive or acquire a unique identifier input via an operator interface of the vehicle (e.g., the vehicle 10, a golf cart, the operator interface 48, etc.). The unique identifier includes at least one of an access code or a credential, a biometric, or a short-range communication signal. In some embodiments, the unique identifier includes the biometric (e.g., at least one of a fingerprint scan, a photograph of the user, a facial scan, a retinal scan, or a voice input), and the vehicle includes a biometric device (e.g., a fingerprint scanner, a camera, or a microphone) configured to acquire the biometric. In some embodiments, the unique identifier includes the access code or the credential, and the vehicle includes a user interface configured to receive the access code or the credential based on an input thereto by the user. In some embodiments, the unique identifier includes the short-range communication signal (e.g., at least one of RFID, NFC, or Bluetooth®), and the vehicle includes a communications interface configured to acquire the short-range communication signal from a portable device of the user (e.g., at least one of a smartphone, a smartwatch, an access fob, or a key). In some embodiments, the short-range communication signal includes the biometric acquired at the portable device.

At step 504, the one or more processing circuits acquire, from a sensor on the vehicle, occupant data regarding occupants of the vehicle. In some embodiments, the sensor includes at least one of a camera, one or more weight sensors, one or more seat switches, one or more seat belt sensors, or an IMU.

At steps 506 and 508, the one or more processing circuits determine information associated with the occupants based on the occupant data. For example, at step 506, the one or more processing circuits determine at least one of a number of the occupants in the vehicle or a weight of the occupants in the vehicle based on the occupant data. At step 508, the one or more processing circuits determine that at least one of the occupants in the vehicle is not wearing a seatbelt based on the occupant data.

At step 510, the one or more processing circuits determine one or more parameters associated with the unique identifier. The one or more parameters define operating conditions of the vehicle. In some embodiments, the one or more parameters include at least one of: a maximum speed of the vehicle, braking capabilities of the vehicle, turning capabilities of the vehicle, a maximum acceleration of the vehicle, permitted operating hours of the vehicle, a permitted number of passengers on the vehicle, available features to be displayed on a display screen of the vehicle, or a permitted geofence of the vehicle.

At step 512, the one or more processing circuits permit operation of the vehicle by the user in accordance with the one or more operating conditions. In some embodiments, the one or more processing circuits permit operation of the vehicle in accordance with the one or more operating conditions and based on the occupant data.

At step 514, the one or more processing circuits detect that one or more occupants detected in the vehicle have exited the vehicle. At step 516, in response to detecting one or more occupants have exited the vehicle, the one or more processing circuits adjust operation of the vehicle. Adjusting operation of the vehicle includes decreasing a speed of the vehicle, permitting increased speed of the vehicle (e.g., as a result of less occupants and/or payload), stopping the vehicle, turning off the vehicle, etc.

Further, in some embodiments, the one or more processing circuits determine that the vehicle is being operated beyond at least one of the one or more parameters. The one or more processing circuits responsively transmit a notification to the user that the vehicle is being operated beyond the at least one of the one or more parameters. In some embodiments, the one or more processing circuits receive a user input indicative of permission from the user to override the one or more parameters for the vehicle. For example, the user receives the notification that the vehicle is being operated beyond a parameters, and the user determines that the vehicle is allowed to operate beyond the parameter. The one or more processing circuits receive an indication from the user, via, for example, an application associated with the vehicle on a user device of the user, that the vehicle is permitted to operate beyond the parameter.

As utilized herein with respect to numerical ranges, the terms “approximately,” “about,” “substantially,” and similar terms generally mean +/-10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf cart system comprising:
a golf cart; and
one or more processing circuits configured to:
acquire a unique identifier associated with a user of the golf cart;
determine one or more parameters associated with the unique identifier, wherein the one or more parameters define one or more operating conditions of the golf cart; and
permit operation of the golf cart by the user in accordance with the one or more operating conditions.

2. The golf cart system of claim 1, wherein the unique identifier includes at least one of an access code or a credential, a biometric, or a short-range communication signal.

3. The golf cart system of claim 2, wherein the unique identifier includes the biometric, wherein the golf cart includes a biometric device configured to acquire the biometric, wherein the biometric device includes at least one of a fingerprint scanner, a camera, or a microphone, and wherein the biometric includes at least one of a fingerprint scan, a photograph of the user, a facial scan, a retinal scan, or a voice input.

4. The golf cart system of claim 2, wherein the unique identifier includes the access code or the credential, and wherein the golf cart includes a user interface configured to receive the access code or the credential based on an input thereto by the user.

5. The golf cart system of claim 2, wherein the unique identifier includes the short-range communication signal, and wherein the golf cart includes a communications interface configured to acquire the short-range communication signal from a portable device of the user.

6. The golf cart system of claim 5, wherein the short-range communication signal includes at least one of RFID, NFC, or Bluetooth®.

7. The golf cart system of claim 5, wherein the short-range communication signal includes the biometric acquired at the portable device.

8. The golf cart system of claim 5, wherein the portable device includes at least one of a smartphone, a smartwatch, an access fob, or a key.

9. The golf cart system of claim 1, wherein the one or more processing circuits includes a processing circuit located on the golf cart.

10. The golf cart system of claim 9, wherein the processing circuit is a first processing circuit, and wherein the one or more processing circuits include a second processing circuit located remote from the golf cart.

11. The golf cart system of claim 1, wherein the one or more parameters include at least one of: a maximum speed of the golf cart, braking capabilities of the golf cart, turning capabilities of the golf cart, a maximum acceleration of the golf cart, permitted operating hours of the golf cart, a permitted number of passengers on the golf cart, available features to be displayed on a display screen of the golf cart, or a permitted geofence of the golf cart.

12. The golf cart system of claim 1, wherein the golf cart includes a sensor configured to acquire occupant data regarding occupants of the golf cart, and wherein the one or more processing circuits are configured to permit the operation of the golf cart by the user in accordance with the one or more operating conditions and based on the occupant data.

13. The golf cart system of claim 12, wherein the sensor includes at least one of a camera, one or more weight sensors, one or more seat switches, one or more seat belt sensors, or an inertial measurement unit.

14. The golf cart system of claim 12, wherein the one or more processing circuits are configured to determine at least one of a number of the occupants in the golf cart or a weight of the occupants in the golf cart based on the occupant data.

15. The golf cart system of claim 14, wherein the one or more processing circuits are configured to:
detect that one or more of the occupants detected in the golf cart have exited the golf cart; and
in response, adjust operation of the golf cart.

16. The golf cart system of claim 12, wherein the one or more processing circuits are configured to determine that at least one of the occupants in the golf cart is not wearing a seatbelt based on the occupant data.

17. The golf cart system of claim 1, wherein the one or more processing circuits are configured to:
determine that the golf cart is being operated beyond at least one of the one or more parameters; and
transmit a notification to the user that the golf cart is being operated beyond the at least one of the one or more parameters.

18. The golf cart system of claim 1, wherein the one or more processing circuits are configured to receive a user input indicative of permission from the user to override the one or more parameters for the golf cart.

19. A recreational vehicle system comprising:
a non-transitory computer-readable medium having instructions stored thereon that, when executed by one or more processors, cause the one or more processors to:
acquire a unique identifier associated with a user of a recreational vehicle;
determine one or more parameters associated with the unique identifier, wherein the one or more parameters define one or more operating conditions of the recreational vehicle; and
permit operation of the recreational vehicle by the user in accordance with the one or more operating conditions.

20. A vehicle system comprising:
a non-transitory computer-readable medium having instructions stored thereon that, when executed by one or more processors, cause the one or more processors to:
acquire a unique identifier associated with a user of a vehicle, wherein the unique identifier includes at least one of an access code or a credential, a biometric, or a short-range communication signal;
determine one or more parameters associated with the unique identifier, wherein the one or more parameters define one or more operating conditions of the vehicle;
acquire occupant data from one or more sensors of the vehicle regarding at least one of a number of occupants in the vehicle, a weight of the occupants in the vehicle, or a use of seatbelts by the occupants in the vehicle, the occupants including the user;
permit operation of the vehicle by the user in accordance with the one or more operating conditions and based on the occupant data;
determine that the vehicle is being operated beyond at least one of the one or more parameters;
transmit a notification in response to the vehicle being operated beyond the at least one of the one or more parameters;
detect that one or more of the occupants have exited the vehicle; and
adjust operation of the vehicle based on updated occupant data.
